(19) United States
(12) Patent Application Publication
(10) Pub. No.: US 2019/0061219 A1
(43) Pub. Date: Feb. 28, 2019

(54) System And Method To Form Attachment Structure

(71) Applicant: GM GLOBAL TECHNOLOGY OPERATIONS LLC, Detroit, MI (US)

(72) Inventors: Jonathan Miller, Grosse Ile, MI (US); Chris A. Oberlitner, Shelby Township, MI (US)

(21) Appl. No.: 15/686,273

(22) Filed: Aug. 25, 2017

(51) Int. Cl. B29C 45/40

(52) U.S. Cl. CPC B29C 45/401; B29L 2031/3041

(57) ABSTRACT

Methods and systems for forming an injection molded part. The system includes a mold cavity housing having a first end and a second end and an opening passing through the housing from the first end to the second end, a lifter member having a first end and a second end, a plurality of attachment formation members, and a groove formed in an outside surface of the lifter member, a lifter guide having a guide member, wherein the rotary lifter translates within the opening in the mold cavity housing and rotates as the guide member travels along the groove in the lifter member.

### INTRODUCTION

The present invention relates generally to the field of vehicles and, more specifically, to an attachment structure formed as part of an injection molding process.

Conventionally, an attachment structure may be configured to attach a mounting member to a corresponding panel. The panel may include a clip hole through which an anchor portion of the mounting member extends to attach the mounting member to the panel. However, for some applications, the formation of holes in the panel may lead to an undesired ingress of water or other contaminants. Additionally, in some applications, such as tight geometries, it may be difficult to form attachment areas.

### SUMMARY

Embodiments according to the present disclosure provide a number of advantages. For example, embodiments according to the present disclosure enable the formation of attachment features on a B-side, or rear-facing, side of injection molded parts, such as, for example and without limitation, vehicle body side moldings. Some embodiments according to the present disclosure utilize rotary action of the lifter to form B-side attachment features on the injection molded part.

In one aspect, a system for forming an injection molded part having one or more attachment features includes a rotary lifter having an outside surface extending between a first end and a second end, the first end having at least one attachment formation member, and a groove formed in the outside surface, a mold cavity housing having a first end and a second end and an opening formed therethrough from the first end to the second end, a mold cavity formed in the second end of the mold cavity housing, and a lifter guide member positioned within the first end of the opening and secured to the first end of the mold cavity housing, the lifter guide member including a guide configured to travel within the groove formed in the rotary lifter. In some aspects, the groove includes a first portion contiguous with a second portion and the second portion is positioned at an angle to the first portion such that as the guide travels within the groove, the rotary lifter is rotated within the opening of the mold cavity housing.

In some aspects, the mold cavity is configured to receive the at least one attachment formation member of the rotary lifter.

In some aspects, the first portion of the groove is parallel to a longitudinal axis of the rotary lifter.

In some aspects, the second portion of the groove is angled with respect to the longitudinal axis of the rotary lifter such that travel of the guide through the second portion of the groove rotates the rotary lifter 60 degrees.

In another aspect, a method for manufacturing an injection molded part having at least one attachment feature includes the steps of providing an injection molding lifter assembly, the lifter assembly including a rotary lifter having a first end and a second end and a groove formed in an outside surface of the rotary lifter, the first end having at least one attachment formation member, a mold cavity housing having an opening formed therethrough and a mold cavity at one end of the opening, and a lifter guide plate positioned within the opening in the mold cavity housing, the lifter guide plate including a guide configured to travel within the groove of the rotary lifter, positioning the rotary lifter within the mold cavity housing such that the at least one attachment formation member is positioned within the mold cavity, injecting molding material into the mold cavity, allowing the molding material to harden around the at least one attachment formation member to form the at least one attachment feature of the injection molded part, and translating the rotary lifter through the mold cavity housing such that the guide rotates the rotary lifter by traveling through the groove to eject the injection molded part from the mold cavity.

In yet another aspect, a system for forming an injection molded part includes a mold cavity housing having a first end and a second end and an opening passing through the housing from the first end to the second end, a lifter member having a first end and a second end, a plurality of attachment formation members, and a groove formed in an outside surface of the lifter member, and a lifter guide having a guide member. In some aspects, the rotary lifter translates within the opening in the mold cavity housing and rotates as the guide member travels along the groove in the lifter member.

In some aspects, the groove includes a first portion aligned with a longitudinal axis of the lifter member, a second portion angled with respect to the longitudinal axis of the lifter member, and a third portion aligned with a longitudinal axis of the lifter member and parallel to the first portion, and the first, second, and third portions are contiguous.

In some aspects, travel of the guide member within the groove rotates the lifter member at least 60 degrees.

In some aspects, the mold cavity housing includes a mold cavity and the plurality of attachment formation members fit within the mold cavity such that as material is injected into the mold cavity, the material surrounds and hardens around the attachment formation members.

In some aspects, the first end of the lifter member includes three attachment formation members, the attachment formation members including tabs extending perpendicular to a longitudinal axis of the lifter member, the tabs distributed equally along a circumference of the first end of the lifter member.

### BRIEF DESCRIPTION OF THE DRAWINGS

The present disclosure will be described in conjunction with the following figures, wherein like numerals denote like elements.

FIG. 1 is a schematic, exploded view of a lifter assembly used to form an attachment structure on an injection molded part, according to an embodiment.

FIG. 2 is a schematic perspective view of a directional groove in a rotary lifter of the lifter assembly of FIG. 1, according to an embodiment.

FIG. 3 is a schematic side view of the rotary lifter and the directional groove of FIG. 2, according to an embodiment.

FIG. 4 is another schematic side view of the rotary lifter and the directional groove of FIG. 2 with the rotary lifter having traveled further within the mold cavity housing, according to an embodiment.

FIG. 5 is a schematic perspective end view of the lifter assembly and further illustrating the mold cavity, according to an embodiment.

FIG. 6 is a schematic side view of an injection molded part being lifted out of the mold cavity of the mold cavity housing of the lifter assembly by the rotary lifter, according to an embodiment.

FIG. 7 is a schematic perspective view of the rotary lifter and the injection molded part, illustrating a plurality of attachment features formed on the injection molded part, according to an embodiment.

FIG. 8 is a schematic perspective view of the injection molded part having a plurality of attachment features formed by the lifter assembly of FIG. 1, according to an embodiment.

FIG. 9 is a schematic flow diagram of a method of forming an injection molded part using the injection molding lifter assembly of FIG. 1.

FIG. 10 is a schematic top view of a fastener configured to engage with the plurality of attachment features of the injection molded part of FIG. 8, according to an embodiment.

FIG. 11 is a schematic perspective view of another fastener configured to engage with the plurality of attachment features of the injection molded part of FIG. 8, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

For some injection molded vehicle parts, such as body side moldings, fastener attachment features can be difficult to locate or place. As discussed herein, the use of a rotating lifter as part of an injection molding lifter assembly can form the attachment features in tight areas where a traditional lifter will not work. Additionally, the use of fasteners having a rotational connection motion to the injection molded part allow the fastener to withstand lateral forces without separating from the part as other designs might allow.

FIG. 1 is a schematic, perspective, exploded view of an injection molding lifter assembly 100, according to an embodiment. In some embodiments, the injection molding lifter assembly 100 includes a rotary lifter 102, a mold cavity housing 104, a bearing 106, and a lifter guide plate 108. The lifter assembly 100 is used to form an injection molded part 110 that includes a plurality of attachment features formed on the B-side, or rear-facing side, of the part 110. The attachment features on the injection molded part are formed around one or more attachment formation members of the rotary lifter 102, which, as it passes longitudinally through the mold cavity housing 104, is rotated by a projection of the lifter guide plate 108 traveling within a groove formed in the outside surface of the rotary lifter 102. The rotational movement of the rotary lifter 102 both removes the attachment formation members of the rotary lifter 102 from the attachment features of the injection molded part 110 and also lifts the part from the mold cavity of the mold cavity housing 104.

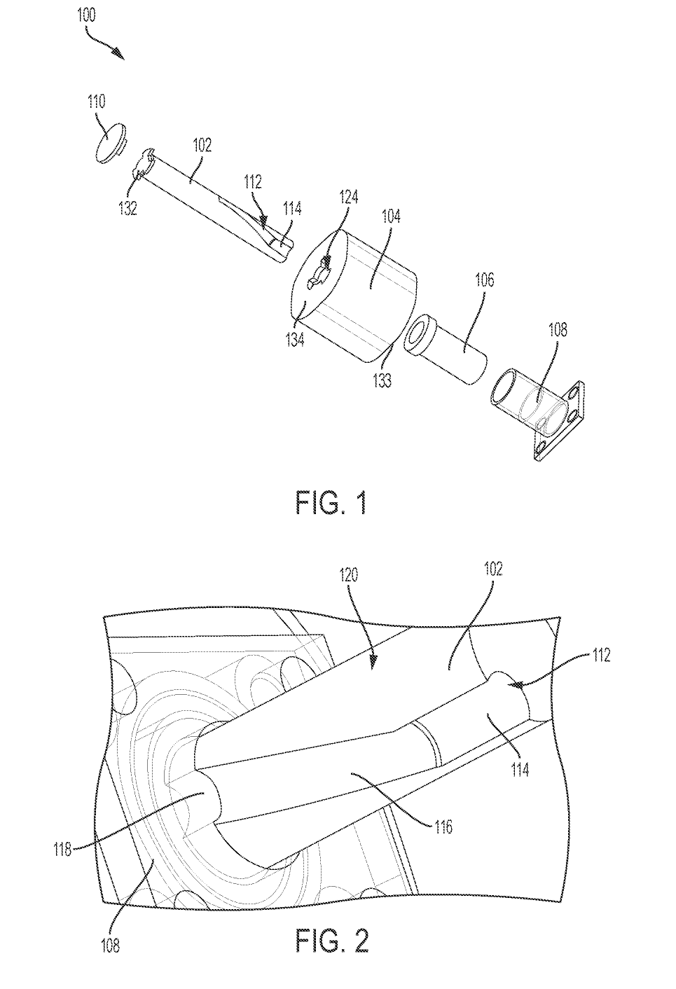

With reference to FIGS. 1 and 2, the rotary lifter 102 is a shaft having a first end 132 and a second opposite the first end. The first end 132 includes a plurality of attachment formation members 103. In some embodiments, the attachment formation members 103 are tabs that extend perpendicularly to the longitudinal axis of the shaft of the rotary lifter 102. The second end includes a channel or groove 112 formed in an outside surface 120 of the rotary lifter 102. The groove 112 includes one or more longitudinally straight portions 114 (that is, the portion 114 is aligned with a longitudinal axis of the lifter 102) and an angled portion 116.

The mold cavity housing 104 has a first end 133 and a second end 134 opposite the first end. An opening passes longitudinally through the mold cavity housing 104 from the first end 133 to the second end 134. The second end 134 of the mold cavity housing 104 includes a mold cavity 124 configured to receive the attachment formation members 103 of the rotary lifter 102. The lifter guide plate 108 fits within the first end 133 of the opening in the mold cavity housing 104 and is secured to the first end 133 of the housing 104 so that the lifter guide plate 108 does not rotate relative to the mold cavity housing 104. As shown in FIG. 1, the rotary lifter 102 fits within the lifter guide plate 108 and travels within the longitudinal opening of the mold cavity housing 104. The lifter guide plate 108 includes a guide 118 configured to travel within the groove 112 such that as the rotary lifter 102 passes through the mold cavity housing 104, the travel of the guide 118 along the groove 112 rotates the rotary lifter 102 within the mold cavity housing 104.

In some embodiments, travel of the guide 118 along the groove 112 rotates the rotary lifter 102 approximately 60 degrees. In other embodiments, the groove 112 is formed such that the rotary lifter 102 rotates between 45 and 75 degrees, between 50 and 70 degrees, or between 55 and 60 degrees. In some embodiments, the groove 112 is formed such that the rotary lifter 102 rotates at least 45 degrees, at least 50 degrees, at least 55 degrees, or at least 60 degrees. As the rotary lifter 102 rotates, the attachment formation members 103 of the rotary lifter 102 are released from the formed attachment features on the injection molded part 110. Further longitudinal travel of the rotary lifter 102 through the mold cavity housing 104 releases the part 110 from the mold cavity 124, as discussed in greater detail below.

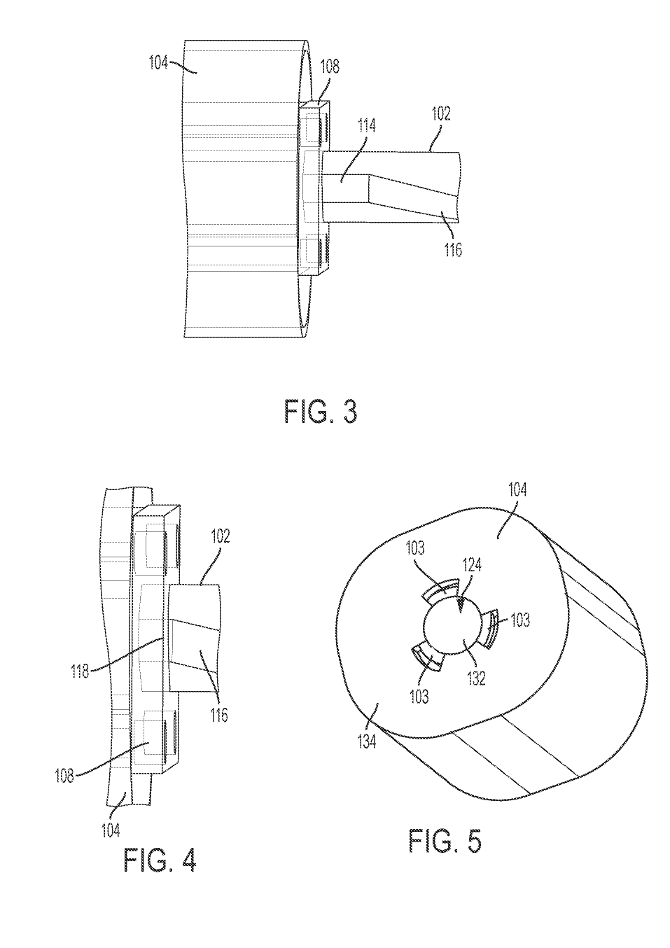

FIG. 3 illustrates a side view of the rotary lifter 102 assembled with the lifter guide plate 108 and the mold cavity housing 104. In some embodiments, the rotary lifter 102 includes a straight groove portion 114 on either end of the angled groove portion 116. As the rotary lifter 102 travels through the mold cavity housing 104 (that is, from right to left as shown in FIG. 3), the guide 118 travels first within the straight portion 114 of the groove 112 such that the rotary lifter 102 travels longitudinally straight through the mold cavity housing 104 before rotating due to the travel of the guide 118 through the angled portion 116 of the groove 112.

As shown in FIG. 4, the rotary lifter 102 has traveled from right to left partially through the mold cavity housing 104. The guide 118 of the mold lifter guide plate 108 has traveled through the straight portion 114 of the groove 112 and is approaching the angled portion 116 of the groove 112.

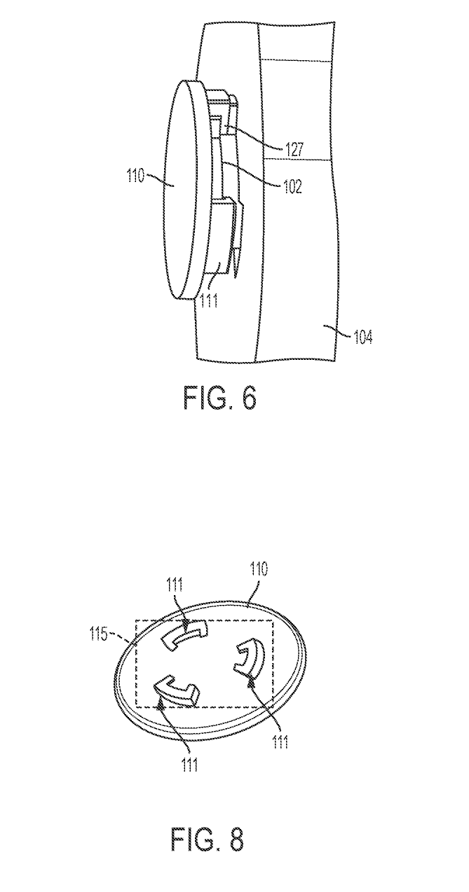

FIG. 5 illustrates a perspective end view of the injection molding lifter assembly 100 in a closed position ready for injection molding. The second end 134 of the mold cavity housing 104 includes the mold cavity 124. As shown, the first end 132 of the rotary lifter 102 includes one or more attachment formation members 103. Three attachment formation members 103 are shown in FIG. 5. However, it may be appreciated that other embodiments may include more or fewer attachment formation members 103. Material injected into the mold cavity 124 fills the area surrounding the attachment formation members 103 such that a plurality of attachment features are formed on the injection molded part, as discussed with respect to FIGS. 6-8.

FIGS. 6-8 illustrate several views of the injection molded part 110 with one or more attachment features 111 and the rotary lifter 102. The material used to form the part 110 is added to the mold cavity 124. As shown in FIG. 6, once the material has cooled, the part 110 is lifted from the mold cavity 124 of the mold cavity housing 104 by the rotary lifter 102.

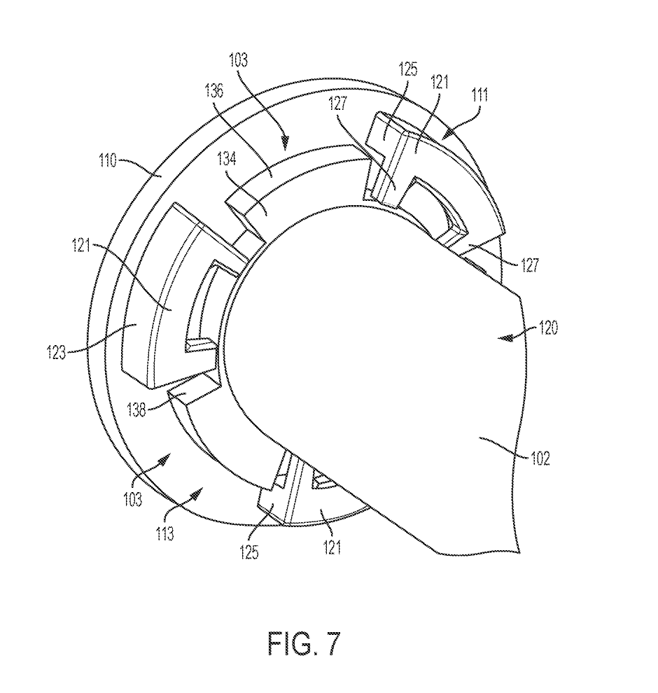

As shown in FIG. 7, the rotary lifter 102 includes a plurality of attachment formation members 103 that, in some embodiments, extend from the first end of the rotary lifter 102 as tabs. Two attachment formation members 103 are shown in FIG. 7, with a third attachment formation member hidden by the shaft of the rotary lifter 102. However, it should be appreciated that other embodiments of the rotary lifter 102 may include more or fewer attachment formation members 103. Each attachment formation member 103 includes a first or top surface 134, a second or outer surface 136, and two third or side surfaces 138. The top surface 134 is generally orthogonal to the outside surface 120 of the rotary lifter 102. The outer surface 136 is generally orthogonal to the top surface 134. The top surface 134 and the outboard surface 136 define a width of the attachment formation member 103. The two side surfaces 138 form the side ends of the tabbed attachment formation member 103 and, along with the outboard surface 136, define a height of the attachment formation member 103.

The attachment formation members 103 of the rotary lifter 102 form one or more attachment features 111 on the rear or B-side of the part 110. The attachment features 111 define an attachment region 115, as shown in FIG. 8. The attachment features 111 allow a fastener to be releasably engaged with the injection molded part 110 via interlocking tabs, as discussed in greater detail herein.

Three attachment features 111 are illustrated in FIGS. 7 and 8, however, it should be appreciated that other embodiments of the injection molded part 110 may include more or fewer attachment features 111, depending on the number of attachment formation members 103 of the rotary lifter 102. With reference to FIG. 7, in some embodiments, each attachment feature 111 includes a first or top surface 121, a second or outer surface 123, and at least one third or side surface 125. The top surface 121 includes one or more projections 127 that overhang and extend toward the outside surface of the rotary lifter 102 (also see FIG. 6). The projections 127 are separated from a rear surface 113 of the injection molded part 110 such that the attachment feature 111 forms an interlocking opening configured to receive a tabbed fastener. As discussed in greater detail herein, a fastener having a plurality of tabs is rotated within the attachment region 115 and engages the attachment features 111 to secure the fastener to the injection molded part 110.

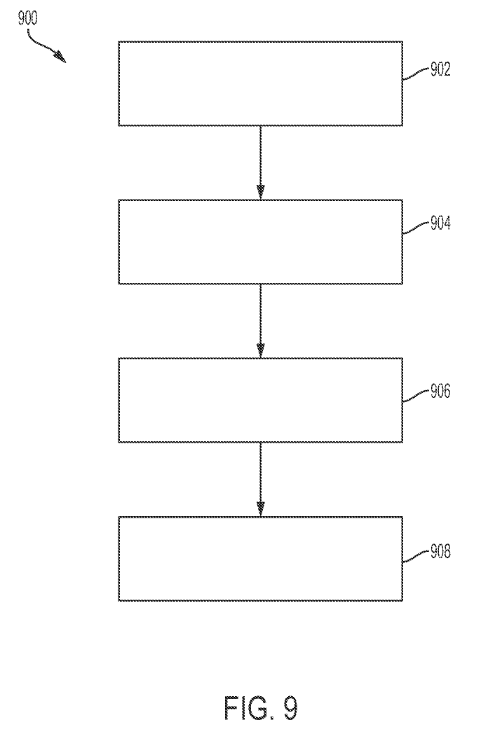

A method 900 of manufacturing the injection molded part 110 having one or more attachment features 111 formed using the rotary lifter 102 is shown in FIG. 9. In some embodiments, the method 900 is performed using the injection molding lifter assembly 100. First, at 902, the molding material is injected into the mold cavity 124 of the mold cavity housing 104. The rotary lifter 102 is aligned within the mold cavity housing 104 such that the attachment formation members 103 are positioned within the cavity 124, as shown in FIG. 5.

At 904, as the molding material hardens around the formation members 103, the injection molded part 110 is formed with the attachment features 111 formed on the rear or B-side of the part 110. Next, at 906, the rotary lifter 102 travels longitudinally through the mold cavity housing 104 such that the guide 118 travels within the groove 112. The groove 112 and guide 118 maintain alignment of the rotary lifter 102 within the mold cavity housing 104. As the rotary lifter 102 travels through the guide plate 108, the guide 118 rotates the rotary lifter 102. Rotation of the rotary lifter 102 rotates the attachment formation members 103 from within the interlocking openings of the attachment features 111 such that the attachment formation members 103 are positioned in the spaces between the attachment features 111. At 908, further translation of the rotary lifter 102 through the mold cavity housing 104 releases the injection molded part 110 from the mold cavity 124, as shown in FIG. 6.

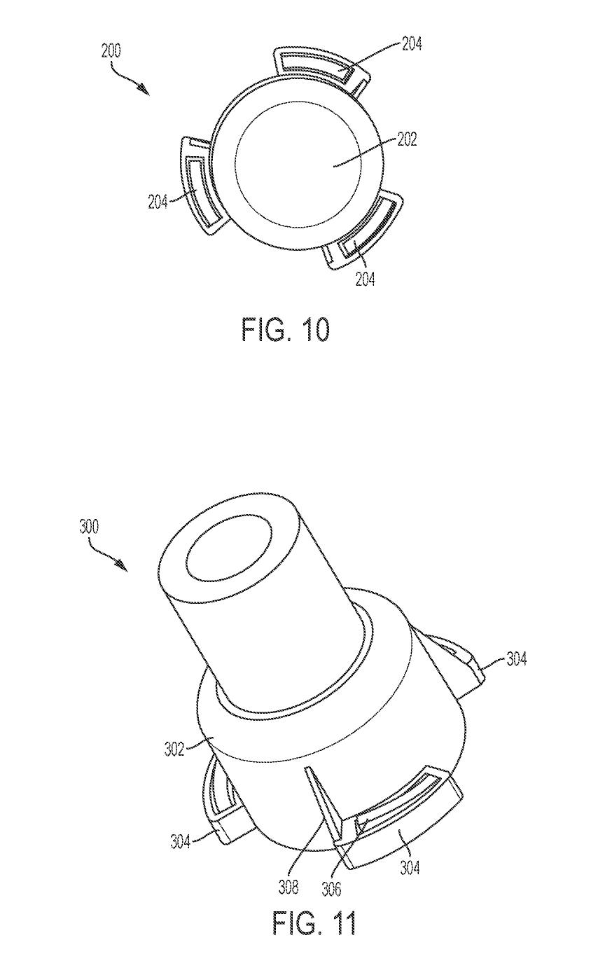

Two exemplary tabbed fasteners are illustrated in FIGS. 10 and 11. As shown in FIG. 10, the fastener 200 includes a body 202 and a plurality of interlocking members or tabs 204. The fastener 300 has three interlocking member 204, however, it can be appreciated that other embodiments of the fastener 200 could include more or fewer interlocking members 204. Each interlocking member 204 engages with one of the attachment features 111 of the injection molded part 110 to releasably secure the fastener 200 to the part 110.

Another embodiment of a fastener 300 is shown in FIG. 11. The fastener 300 includes a body 302 and a plurality of interlocking members or tabs 304. In some embodiments, each tab 304 includes a retention snap 306. The retention snap 306 is an angled ramp such that as the interlocking member 304 rotates within the attachment feature 111, the retention snap 306 engages with the attachment feature 111 to minimize or prevent the fastener 300 from rotating out of an interlocked position. In some embodiments, the fastener 300 includes an end member 308. The end member 308 extends vertically at one end of the tab 304 and orthogonal to the tab 304. The end member 308 acts as a barrier to stop rotation and prevent over rotation of the tab 204 within the attachment feature 111.

To attach the fastener 200, 300 to the injection molded part 110, the fastener 200, 300 is placed within the attachment region 115 of the part 110 such that the tabs 204, 304 are aligned with the spaces between the attachment features 111. The fastener 200, 300 is then rotated counterclockwise such that the tabs 204, 304 pass beneath the overhang created by the projections 127 of the attachment features 111. The retention snaps 306 engage with the projections 127 to secure the tab within the interlocking opening. Further rotation of the tab 204, 304 within the interlocking opening formed by the attachment feature 11 is arrested by the end member 308.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus_{;} for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, hut that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-manges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system for forming an injection molded part having one or more attachment features, comprising:
a rotary lifter having an outside surface extending between a first end and a second end, the first end having at least one attachment formation member, and a groove formed in the outside surface;
a mold cavity housing having a first end and a second end and an opening formed therethrough from the first end to the second end, a mold cavity formed in the second end of the mold cavity housing; and
a lifter guide member positioned within the first end of the opening and secured to the first end of the mold cavity housing, the lifter guide member including a guide configured to travel within the groove formed in the rotary lifter;
wherein the groove includes a first portion contiguous with a second portion and the second portion is positioned at an angle to the first portion such that as the guide travels within the groove, the rotary lifter is rotated within the opening of the mold cavity housing.

2. The system of claim 1, wherein the mold cavity is configured to receive the at least one attachment formation member of the rotary lifter.

3. The system of claim 1, wherein the first portion of the groove is parallel to a longitudinal axis of the rotary lifter.

4. The system of claim 3, wherein the second portion of the groove is angled with respect to the longitudinal axis of the rotary lifter such that travel of the guide through the second portion of the groove rotates the rotary lifter 60 degrees.

5. A method for manufacturing an injection molded part having at least one attachment feature, the method comprising:
providing an injection molding lifter assembly, the lifter assembly comprising a rotary lifter having a first end and a second end and a groove formed in an outside surface of the rotary lifter, the first end having at least one attachment formation member, a mold cavity housing having an opening formed therethrough and a mold cavity at one end of the opening, and a lifter guide plate positioned within the opening in the mold cavity housing, the lifter guide plate including a guide configured to travel within the groove of the rotary lifter;
positioning the rotary lifter within the mold cavity housing such that the at least one attachment formation member is positioned within the mold cavity;
injecting molding material into the mold cavity;
allowing the molding material to harden around the at least one attachment formation member to form the at least one attachment feature of the injection molded part; and
translating the rotary lifter through the mold cavity housing such that the guide rotates the rotary lifter by traveling through the groove to eject the injection molded part from the mold cavity.

6. A system for forming an injection molded part, comprising:
a mold cavity housing having a first end and a second end and an opening passing through the housing from the first end to the second end;
a lifter member having a first end and a second end, a plurality of attachment formation members, and a groove formed in an outside surface of the lifter member; and
a lifter guide having a guide member;
wherein the rotary lifter translates within the opening in the mold cavity housing and rotates as the guide member travels along the groove in the lifter member.

7. The system of claim 6, wherein the groove comprises a first portion aligned with a longitudinal axis of the lifter member, a second portion angled with respect to the longitudinal axis of the lifter member, and a third portion aligned with a longitudinal axis of the lifter member and parallel to the first portion, and the first, second, and third portions are contiguous.

8. The system of claim 7, wherein travel of the guide member within the groove rotates the lifter member at least 60 degrees.

9. The system of claim 6, wherein the mold cavity housing includes a mold cavity and the plurality of attachment formation members fit within the mold cavity such that as material is injected into the mold cavity, the material surrounds and hardens around the attachment formation members.

10. The system of claim 6, wherein the first end of the lifter member comprises three attachment formation members, the attachment formation members comprising tabs extending perpendicular to a longitudinal axis of the lifter member, the tabs distributed equally along a circumference of the first end of the lifter member.
